(19) United States
(12) Patent Application Publication
(10) Pub. No.: US 2008/0094311 A1
(43) Pub. Date: Apr. 24, 2008

(54) INTERACTIVE HYPERWALL FOR VISUALIZATION, SIMULATION, GAMING

(75) Inventors: Marc Garbey, Houston, TX (US); Christophe Picard, Houston, TX (US)

Correspondence Address: CONLEY ROSE, P.C.;David A. Rose, P. O. BOX 3267, HOUSTON, TX, 77253-3267, US

(73) Assignee: UNIVERSITY OF HOUSTON SYSTEM, Houston, TX (US)

(21) Appl. No.: 11/874,762

(22) Filed: Oct. 18, 2007

Related U.S. Application Data
(60) Provisional application No. 60/862,292, filed on Oct. 20, 2006.

(51) Int. Cl. G09G 5/00

(52) U.S. Cl. 345/1.3

(57) ABSTRACT

An interactive hyperwall containing a plurality of meta-monitors having a computer with an operating system and bearing multiple graphic cards, multiple displays supported by the graphic cards, and a computer-readable storage device with software; a hyperwall system, for simultaneous visualization of different representations of multidimensional data, the hyperwall system containing an interactive hyperwall. The components of the hyperwall system used may be ‘off the shelf’ components. Open source software may be used to achieve the display; and a method of simultaneously visualizing different representations of data by creating an interactive hyperwall. The interactive hyperwall includes a plurality of meta-monitors, each meta-monitor having a computer with a network ID and multiple graphic cards, multiple displays supported by the graphic cards, and a storage device with software. Polling is performed to determine if visualization is requested and, if visualization is requested, data representations are displayed.

### CROSS-REFERENCE TO RELATED APPLICATIONS

This application claims the benefit under 35 U.S.C. §119(e) of U.S. Provisional Patent Application No. 60/862,292 filed Oct. 20, 2006, the disclosure of which is hereby incorporated herein by reference.

### BACKGROUND

1. Field of the Invention

This invention relates generally to a system and method for interactively manipulating multidimensional data. More specifically, this disclosure provides a system and method for simultaneously displaying a plurality of representations of multidimensional data on multiple monitors with a single remote device.

2. Background of the Invention

Analysis of multiple sets of related data is sometimes best accomplished by visual display. Because the size of data to be analyzed may be such that a large amount of screen real-estate (beyond that provided by a normal personal computer's monitor) is required, a normal personal computer's monitor may not be adequate for such display. Readily available, high-end display screens typically provide only 2560×1600 pixels.

One current method of displaying different representations of a data set supplied by multiple computers/devices is to have a single display screen that presents the different data representations by time sharing the display screen. The contents of the screen are switched between the different data representations from the multiple computer/devices. This means that the different data representations are not displayed simultaneously. Rather, the different data representations are displayed one at a time and time-share the display screen.

To overcome this limitation, multiple monitors are sometimes used to display comparative data or a single image which is better displayed at higher resolution on multiple monitors. This simultaneous display of different sets of data on a single desktop can be achieved in many ways, and a variety of different technologies have been used to date. Problems related to hardware, operating systems, software and access to the display, however, remain.

Another current method is to use a hyperwall that displays a desktop. The display of the desktop is split among several computers, each having a mouse and keyboard and each computer performing a computation for the portion of the screen it represents. For example, rather than the data being displayed with a resolution of 1200×800 on a single screen, the data may be displayed with a resolution of 4800×3600 on a 4×4 screen, but it is only one session, i.e. one larger version of the first display.

Accordingly, there is a need for improvement of apparatus and methods for creating and operating a simultaneous display of data. This invention addresses such a need.

### BRIEF SUMMARY

Disclosed herein is an interactive hyperwall comprising a plurality of meta-monitors, wherein each meta-monitor comprises a computer having an operating system and bearing multiple graphic cards; multiple displays supported by the graphic cards; and a computer-readable storage device comprising software. The hyperwall may comprise at least two meta-monitors, wherein each of the multiple graphic cards supports at least two displays. The hyperwall may also comprise four meta-monitors.

In embodiments, at least one computer of the plurality of meta-monitors uses an operating system different from the operating system of at least one other computer. The hyperwall may have at least one computer comprising public-domain software. The public-domain software may be Xinerama.

The hyperwall may comprise four meta-monitors, wherein each meta-monitor comprises a computer comprising at least two graphic cards, at least two monitors supported by each of the at least two graphic cards, and a computer-readable storage device comprising software.

Also disclosed herein is a hyperwall system, for simultaneous visualization of different representations of data. The hyperwall system comprises a plurality of meta-monitors, wherein each meta-monitor comprises a computer having an operating system and bearing multiple graphic cards, multiple displays supported by the graphic cards, and a computer-readable storage device comprising software. In embodiments, at least one computer of the plurality of meta-monitors, of the hyperwall system, has an operating system different from the operating system of at least one other computer.

The hyperwall system may further comprise remote controlling apparatus for controlling the meta-monitors. In embodiments, the remote control apparatus comprises a mouse, a keyboard and a remote computer with a computer-readable storage device comprising software.

In some embodiments, the computer of each meta-monitor, of the hyperwall system, has an operating system selected from the group consisting of LINUX®, WINDOWS®, MAC OS® and UNIX®. In certain embodiments, at least one of the plurality of meta-monitors of the hyperwall system comprises two graphic cards and four monitors. The software of the hyperwall system may comprise public-domain software. The public-domain software may comprise Xinerama.

The remote computer with a computer-readable storage device may also comprise public-domain software. The public-domain software could comprise at least one selected from the group consisting of Kompose and Synergy.

Also disclosed herein is a method of simultaneously visualizing different representations of data. The method comprises creating an interactive hyperwall comprising a plurality of meta-monitors, each meta-monitor comprising a computer having a network ID and comprising multiple graphic cards, multiple displays supported by the graphic cards, and a storage device comprising software; wherein each computer comprises a network ID allowing communication among the meta-monitors; polling to determine if visualization is requested; and displaying data representations if visualization is requested. The method may further comprise activating the multiple displays of the plurality of meta-monitors. The method may further comprise providing a remote computer in communication with the interactive hyperwall and optionally comprising a remote computer monitor. The display of data representations if visualization is requested may further comprise updating requested data representations and storing the updated data representations in a database.

The display of data representations if visualization is requested may further comprise displaying the updated data representations on the applicable meta-monitors of the hyperwall and optionally synchronously displaying the updated data representations on the remote computer monitor.

The method may also comprise polling to determine if further visualization is requested. The polling may be performed periodically to determine if visualization is requested or if visualization is complete. The display of the updated data representation may be terminated upon determination that visualization is complete.

### BRIEF DESCRIPTION OF THE DRAWINGS

For a detailed description of the preferred embodiments of the invention, reference will now be made to the accompanying drawings in which:

FIG. 1 is a diagram of a hyperwall system according to an embodiment of the invention, the diagram illustrating the interaction of the various possible hardware and software components.

FIG. 2 is a flow chart of the steps of a method according to an embodiment of the invention.

### NOTATION AND NOMENCLATURE

Throughout the following description and claims, certain terms are used to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

Herein disclosed are a system and method for simultaneous display/visualization of different representations of multidimensional data. Some examples of types of multidimensional data include but are not limited to: (a) different representations in space and/or time of the same data, (b) multiple variables of the same experiment/simulation, or (c) like variables with different parameters. The system comprising hyperwall 100 may be used to: (a) provide a better tool for visualizing related data, (b) understand a workflow, and/or (c) dynamically and simultaneously influence the different aspects of visualization.

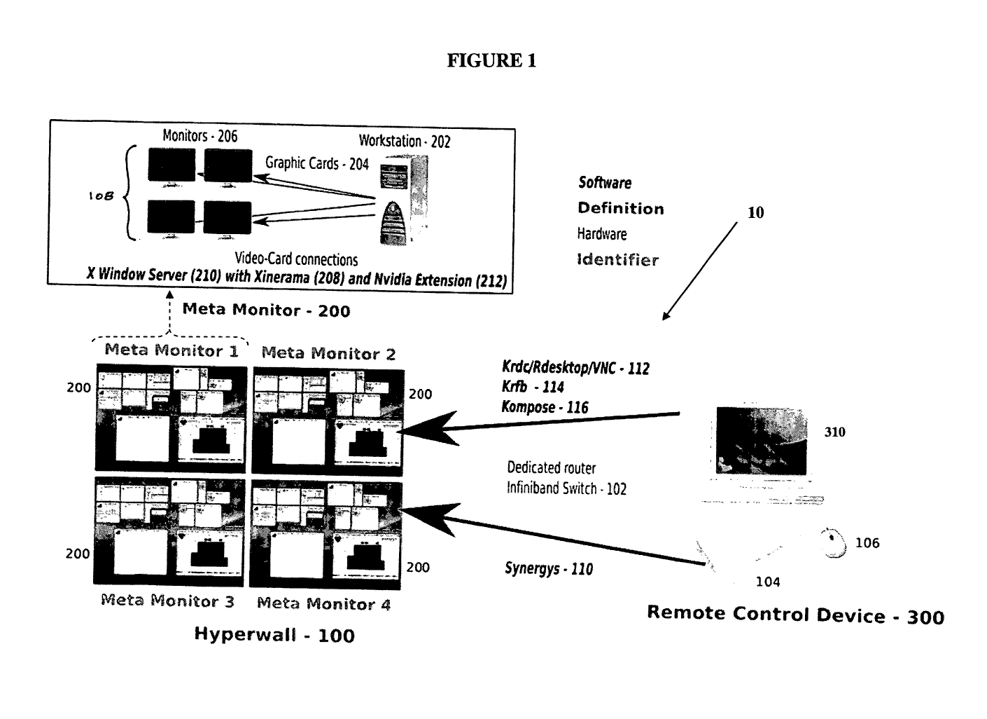

FIG. 1 is a diagram of a hyperwall system 10 according to an embodiment of the invention. Hyperwall system 10 comprises remote control apparatus 300 in communication with interactive hyperwall 100 which comprises a plurality of meta-monitors 200. FIG. 1 illustrates the interaction of the various possible hardware and software components. Interactive hyperwall 100 may communicate via various hardware and software with remote control apparatus 300. Interactive hyperwall 100 may thereby facilitate the simultaneous interactive manipulation and/or display of multidimensional data to provide a broader perspective of a given context.

### Hardware

Interactive hyperwall 100 comprises a plurality of meta-monitors 200. Each meta-monitor 200 comprises a meta-monitor workstation 202 (e.g. a computer) comprising a storage device containing software and multiple meta-monitor graphic cards 204 and multiple meta-monitor monitors 206 supported by meta-monitor graphic cards 204. The output of each meta-monitor 200 may be referred to as the meta-monitor display 108.

As mentioned, interactive hyperwall 100 comprises workstation 202 and associated graphic cards 204. Workstation 202 and graphic cards 204 may be any workstation and graphic cards known to those of skill in the art. The number of monitors 206 controlled by each workstation 202 is dependent on the available connectivity of each graphic card 204. In the embodiment of FIG. 1, each workstation 202 comprises two graphic cards 204, each of which drives two output meta-monitor monitors 206. This group (meta-monitor workstation/meta-monitor graphic-cards/meta-monitor monitors) is an independent entity referred to as a meta-monitor 200.

Hyperwall system 10 comprises a plurality of meta-monitors. In embodiments, hyperwall system 10 comprises two meta-monitors. In some embodiments, hyperwall system 10 comprises at least three meta-monitors. In some embodiments, hyperwall system 10 comprises four meta-monitors. In the embodiment of FIG. 1, interactive hyperwall 100 comprises four independent meta-monitors 200; Meta-Monitor 1, Meta-Monitor 2, Meta-Monitor 3, and Meta-Monitor 4. In certain embodiments of hyperwall system 10, at least one of the plurality of meta-monitors 200 comprises two meta-monitor graphic cards 204 and four meta-monitor monitors 206.

In embodiments, hyperwall 10 is remotely controlled. In embodiments, multiple displays are interactively driven with a single remote control apparatus 300. In embodiments, the plurality of meta-monitors communicates through an infiniband switch 102, as shown in FIG. 1. This switch allows the use of a remote control apparatus 300 to control interactive hyperwall 100. Remote control of hyperwall 100 may be affected through the use of any suitable remote control apparatus as known to those of skill in the art. For example, in the embodiment of FIG. 1, interactive hyperwall 100 is remotely controlled with laptop 310 comprising independent keyboard 104 and mouse 106 which are shared by the meta-monitors 200 and remotely control hyperwall 100. In embodiments hyperwall system 10 comprises a single mouse and keyboard, the system displaying multiple screens in high level resolution. In embodiments, the hardware of hyperwall system 10 is off-the-shelf hardware. In embodiments, the hyperwall system of the present disclosure combines off-the-shelf hardware and public-domain software to interactively drive the hyperwall with a single remote device.

In embodiments, the visualization is implemented by means of multiple monitors 206 controlled by independent workstations 202.

### Software Implementation

In embodiments, not all of the computers and devices that supply the different representations of the data set are controlled by the same operating system. In some embodiments, the system and method herein disclosed enable input from computers with different operating system(s). In embodiments, hyperwall 100 is designed to be functional under different operating systems. Such operating systems include, but are in no way limited to, LINUX® 32-bit, LINUX® 64-bit, WINDOWS® 32-bit, WINDOWS® 64-bit, and MAC OS®. The operating system is selected to be operable with the software to be used with hyperwall 100, e.g. visualization software. In some embodiments of hyperwall system 10, at least one computer 202 of the plurality of meta-monitors 200 uses an operating system different from the operating system of at least one other computer 202.

In some embodiments, the operating system comprises a LINUX® operating system. In such embodiments, display 108 (the four screens/monitors 206 in each meta-monitor 200) may be managed through X11 (X.org Foundation, Release X11R7.1). The Xinerama extension 208 (FIG. 1) of the X WINDOW SYSTEM® server software 210 may be used and allow a display on the four monitors/screens 206 of each meta-monitor 200. To improve the frame rate, the Xinerama extension software 208 from the X11 may be combined, as shown in the embodiment of FIG. 1, with a TWINVIEW® extension from the NVIDIA® drivers (the NVIDIA® Extension software 212).

Hyperwall 100 may be controlled by any means known to those of skill in the art. In embodiments, hyperwall 100 is controlled by means of a single keyboard 104 and a single mouse 106. This functionality may be provided by any means known to one of skill in the art. In embodiments, as shown in FIG. 1, this functionality is provided by the software Synergy 110. Synergy may serve to facilitate the sharing of a single mouse 106 and keyboard 104 between multiple computers/workstations 202 with different operating systems, each with its own display monitor(s) 206, without the need for special hardware.

Synergy allows sharing a single mouse and keyboard between multiple computers with different operating systems, each with its own display, without special hardware. It is intended for users with multiple workstations 202 on their desk. Each one of them controlled a meta-monitor comprises of monitor(s) 206. Redirecting mouse 106 and keyboard 104 simply requires moving the mouse 104 off the edge of the screen. Synergy 110 also merges the clipboards of all the meta-monitors into one, allowing cut-and-paste between meta-monitors. Synergy 110 is open source and released under the GNU Public License (GPL).

Remote desktop control may be achieved by any means known to one of skill in the art. In embodiments, for example, remote desktop control is achieved using software comprising RDesktop/Krdc 112, Krfb 114 and Kompose 116. Krfb 114 and Krdc 112 are part of the network module inside KDE® and make use of KDE® libraries. These technologies may, in embodiments, be replaced by other technologies available on other platforms that may not rely on the KDE® libraries. For example, in alternative embodiments, remote desktop control is achieved with the equivalent WINDOWS® applications including, for example, Remote Desktop Control and VNC® (not shown).

Kompose 116 is also a KDE® technology based on KDE® libraries. Kompose 116 offers a way to manage a large number of windows/monitors/screens 206 on different virtual desktops/workstations 202. It creates a full screen view where every window/monitor 206 is represented by a scaled screenshot of its own. The KDE® framework, may enable creation of screenshots “on the fly” while working without much overhead. The image scaling may be through a high performance image library, such as Imlib2. A similar technology for Kompose is Expose for MAC OS®. The main difference is that Kompose displays virtual desktop information in a way that may be used to select which meta-monitor 200 is being controlled.

In embodiments, at least some of the software is public-domain software. In some embodiments, all of the software is public-domain software. In embodiments, the system may be remotely controlled. In embodiments, off-the-shelf hardware and public domain software are used to interactively drive multiple displays with a single remote device. In embodiments, different modalities (data representations) in different meta-monitors are displayed and remotely manipulated as if the modalities were on the same computer (except for the sharing). In embodiments, the different modalities are displayed and remotely manipulated with a single mouse and keyboard although the multiple application sessions are indeed independent and may coexist singularly and utilize disparate operating systems (e.g. LINUX®, WINDOWS®, UNIX®, MAC OS®, etc.) on the various computers of the meta-monitors.

### Visualization/Data Manipulation Software

The data representation/visualization may be performed by any data manipulation and/or visualization software known to those of skill in the art. In some embodiments, interactive visualization with a hyperwall system 10 according to the present disclosure is achieved with software selected from the group consisting of VisIt, MATLAB®, and combinations thereof, as described further in the example that follows.

### Method

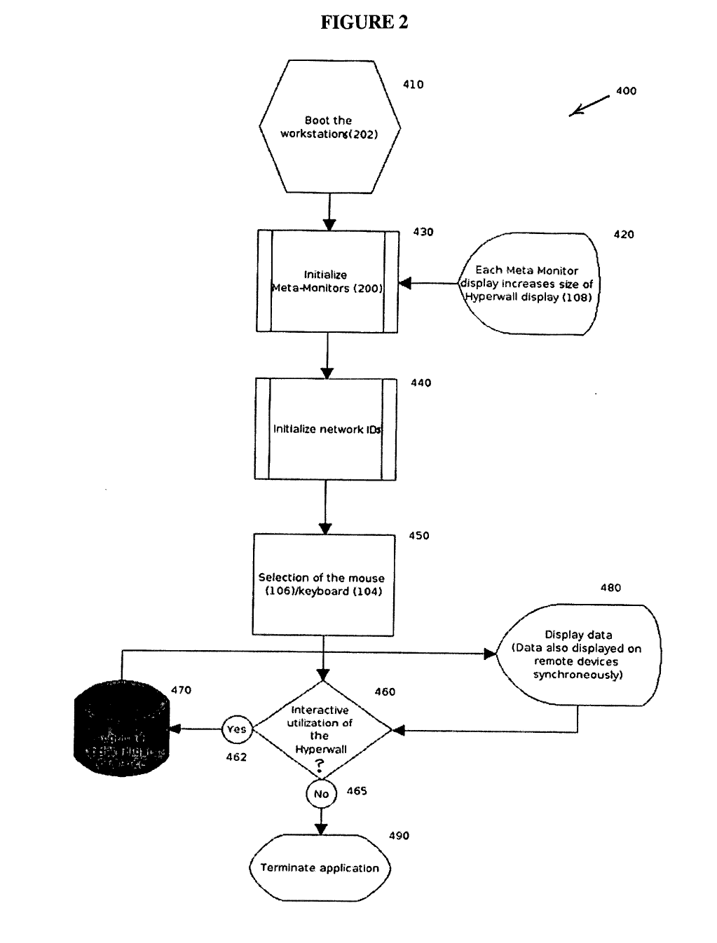

Also disclosed herein is a method for simultaneously visualizing different representations of multidimensional data utilizing an interactive hyperwall. FIG. 2 is a flow chart of the steps of a method according to an embodiment of the invention. The method, not necessarily in the order described, 400 comprises: (a) individually booting 410 each computer/workstation 202 of a hyperwall 100, the hyperwall comprising a plurality of meta-monitors 200, each meta-monitor 200 comprising a workstation 202 bearing multiple meta-monitor graphic cards 204, multiple meta-monitor monitors 206 supported by graphic cards 204, and a storage device comprising software; (b) activating 420 each meta-monitor display 108 to increase the size of the hyperwall display 108; (c) initializing 430 the meta-monitors 200; (d) initializing 440 the network ID for each workstation 202 to allow communication with the other workstations 202; (e) selecting 450 mouse 106 and keyboard 104; (f) polling 460 to see if visualization is requested; in embodiments, the polling forms a portion of a continuous loop; (g) if visualization is requested 462, updating and storing 470 the requested data representations in database and displaying 480 on the applicable meta-monitors 200 of the hyperwall 100. The updated data representations may be synchronously displayed with remote devices (if applicable). The method may further comprise: (h) terminating 490 the application if end-of-visualization requests are indicated 465.

In embodiments, the method for simultaneously visualizing different representations of multidimensional data utilizing an interactive hyperwall comprises: (a) booting computers of an interactive hyperwall comprising a plurality of meta-monitors, each meta-monitor comprising a computer having a network ID and comprising multiple graphic cards, multiple displays supported by the graphic cards, and a storage device comprising software; (b) activating the multiple displays of the plurality of meta-monitors; (c) initializing the meta-monitors; (d) initializing the network ID communication of each computer of the plurality of meta-monitors, thereby allowing communication among the meta-monitors; (d) selecting a remote computer in communication with the interactive hyperwall and optionally comprising a remote computer monitor; (e) polling to determine if visualization is requested; and (f) displaying data representations if visualization is requested. In certain embodiments, displaying data representations if visualization is requested further comprises updating requested data representations and storing the updated data representations in a database. Displaying data representations if visualization is requested may further comprise displaying the updated data representations on the applicable meta-monitors of the hyperwall. In some embodiments, displaying data representations if visualization is requested further comprises synchronously displaying the updated data representations on the remote computer monitor. In embodiments of the method for simultaneously visualizing different representations of multidimensional data utilizing an interactive hyperwall, the method further comprises repeating polling to determine if further visualization is requested.

In embodiments of the method, polling to determine if visualization is requested is performed periodically to determine if visualization is requested or if visualization is complete. The method may further comprise terminating display of the updated data representation upon determination that visualization is complete.

### Applications

Applications for the disclosed system and method for interactively manipulating multidimensional data exist in many fields including, but not limited to, medical, Homeland Security and games. In embodiments, the disclosed hyperwall system and method are used for applications selected from medical applications, Homeland Security applications, gaming applications, and combinations thereof. The descriptions of the following applications are meant by way of example and are not meant to limit the scope of the invention.

In embodiments, the disclosed hyperwall system 10 and method 400 may be applied to clinical exams and allow a doctor to interactively manage different image modalities (data representations). Such modalities include, without limitation, X-ray, MRI, angiogram, PET, and combinations thereof. The disclosed hyperwall system and method of using same may be used to display several different image modalities of the same subject in, for example, a side-by-side arrangement. This data representation may facilitate a better interpretation and diagnostic of the medical data. Similarly, the disclosed system and method may be used to display a large number of slices of a 3-D image data set from a singular organ. This may allow a doctor to navigate fairly quickly through a large data set and localize the most relevant image. A third medical application comprises using the disclosed system and method to present one medical image on all displays with various levels of magnification/zoom. Yet another medical application is running the same process (image segmentation, wavelet analysis, hemo-dynamic simulation) with a set of n parameters that can all be simultaneously displayed on hyperwall 100 on all displays/monitors 206.

As mentioned hereinabove, the system and method can be used in a Homeland Security context. The system may be used to navigate among a large data set of images and/or simulations by displaying some representation in parallel. Following the terminology of parallel computing, where each process matches each display of the hyperwall 100, a user can either run a single program multi-instruction code, or a single instruction application with multiple datasets. The key element is that hyperwall system 10 of the present invention uses one device as the front end.

As mentioned above, another desirable application for the disclosed system and method is for gaming. The disclosed system and method may be used to display larger amounts of information or to extend the environment that is displayed in games. Such games include, for example, well-known games such as NINTENDO DS®, FLIGHT SIMULATOR®, etc.

### EXAMPLE

Current interactive visualization with a hyperwall system 10 according to the present disclosure was achieved with two different software applications, namely VisIt and MATLAB®.

VisIt is a free interactive parallel visualization and graphical analysis tool for viewing scientific data on UNIX® and PC platforms. Users can quickly generate visualizations from their data, animate them through time, manipulate them, and save the resulting images for presentations. VisIt contains a rich set of visualization features so that the user can view data in a variety of ways. It can be used to visualize scalar and vector fields defined on two- and three-dimensional (2D and 3D) structured and unstructured meshes. VisIt was designed to handle very large data set sizes in the terascale range and yet can also handle small data sets in the kilobyte range. VisIt was developed by the Department of Energy (DOE) Advanced Simulation and Computing Initiative (ASCI) to visualize and analyze the results of terascale simulations. It was developed as a framework for adding custom capabilities and rapidly deploying new visualization technologies. Although the primary driving force behind the development of VisIt was for visualizing terascale data, it is also well suited for visualizing data from typical simulations on desktop systems. Because of its applicability beyond visualizing terascale data, VisIt freely available.

MATLAB® is a high-level technical computing language and interactive environment for algorithm development, data visualization, data analysis, and numeric computation. All the graphics features required to visualize engineering and scientific data are available in MATLAB®. These include 2-D and 3-D plotting functions, 3-D volume visualization functions, tools for interactively creating plots, and the ability to export results to all popular graphics formats.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference in the Description of the Related Art is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. An interactive hyperwall comprising:
a plurality of meta-monitors, wherein each meta-monitor comprises a computer having an operating system and bearing multiple graphic cards; multiple displays supported by the graphic cards; and a computer-readable storage device comprising software.

2. The hyperwall of claim 1 comprising at least two meta-monitors, wherein each of the multiple graphic cards supports at least two displays.

3. The hyperwall of claim 2 comprising four meta-monitors.

4. The hyperwall of claim 1, wherein at least one computer of the plurality of meta-monitors uses an operating system different from the operating system of at least one other computer.

5. The hyperwall of claim 1 wherein at least one computer comprises public-domain software.

6. The hyperwall of claim 5 wherein the public-domain software is Xinerama.

7. An interactive hyperwall comprising four meta-monitors, wherein each meta-monitor comprises a computer comprising at least two graphic cards, at least two monitors supported by each of the at least two graphic cards, and a computer-readable storage device comprising software.

8. A hyperwall system, for simultaneous visualization of different representations of data, the hyperwall system comprising:
a plurality of meta-monitors, wherein each meta-monitor comprises a computer having an operating system and bearing multiple graphic cards, multiple displays supported by the graphic cards, and a computer-readable storage device comprising software.

9. The system of claim 8, wherein at least one computer of the plurality of meta-monitors has an operating system different from the operating system of at least one other computer.

10. The system of claim 8 further comprising remote controlling apparatus for controlling the meta-monitors.

11. The system of claim 10 wherein the remote controlling apparatus comprises a mouse, a keyboard and a remote computer with a computer-readable storage device comprising software.

12. The system of claim 8, wherein the computer of each meta-monitor has an operating system selected from the group consisting of LINUX®, WINDOWS®, MAC OS® and UNIX®.

13. The system of claim 8, wherein at least one of the plurality of meta-monitors comprises two graphic cards and four monitors.

14. The system of claim 8 wherein the software comprises public-domain software.

15. The system of claim 14 wherein the public-domain software comprises Xinerama.

16. The system of claim 11 wherein the software of the remote computer with a computer-readable storage device comprises public-domain software.

17. The system of claim 16 wherein the public-domain software comprises at least one selected from the group consisting of Kompose and Synergy.

18. A method of simultaneously visualizing different representations of data, the method comprising:
creating an interactive hyperwall comprising a plurality of meta-monitors, each meta-monitor comprising a computer having a network ID and comprising multiple graphic cards, multiple displays supported by the graphic cards, and a storage device comprising software; wherein each computer comprises a network ID allowing communication among the meta-monitors;
polling to determine if visualization is requested; and
displaying data representations if visualization is requested.

19. The method of claim 18 further comprising activating the multiple displays of the plurality of meta-monitors.

20. The method of claim 18 further comprising providing a remote computer in communication with the interactive hyperwall and optionally comprising a remote computer monitor.

21. The method of claim 20 wherein displaying data representations if visualization is requested further comprises updating requested data representations and storing the updated data representations in a database.

22. The method of claim 21 wherein displaying data representations if visualization is requested further comprises displaying the updated data representations on the applicable meta-monitors of the hyperwall and optionally synchronously displaying the updated data representations on the remote computer monitor.

23. The method of claim 18 further comprising repeating polling to determine if further visualization is requested.

24. The method of claim 18 wherein polling to determine if visualization is requested is performed periodically to determine if visualization is requested or if visualization is complete.

25. The method of claim 24 further comprising terminating display of the updated data representation upon determination that visualization is complete.
